(19) United States
(12) Patent Application Publication
(10) Pub. No.: US 2025/0085258 A1
(43) Pub. Date: Mar. 13, 2025

(54) PROCESS MONITORING

(71) Applicant: Tribosonics Limited, Sheffield (GB)

(72) Inventor: Brian Philip Harper, Sheffield (GB)

(21) Appl. No.: 18/723,168

(22) PCT Filed: Dec. 20, 2022
(86) PCT No.: PCT/GB2022/053316

§ 371 Date: Jun. 21, 2024

(30) Foreign Application Priority Data
Dec. 23, 2021 (GB) 2118941.0

(51) Int. Cl. G01N 29/44; G01N 29/04

(52) U.S. Cl. CPC G01N 29/4418; G01N 29/041

(57) ABSTRACT

An apparatus for monitoring a mechanical system comprising a moving surface arranged to undertake periodic motion, the periodic motion having a time period. The apparatus comprises a controller configured to: control a first transducer to emit acoustic waves onto the moving surface during first and second time periods of the periodic motion; receive signals generated by the first transducer or a second transducer, wherein the received signals represent one or both of i) reflections of the acoustic waves from the moving surface and ii) acoustic waves having travelled through the mechanical system; process the received signals to obtain at least one first measurement indicative of a signal received during the first time period, and to obtain at least one second measurement indicative of a signal received during the second time period; compare the at least one first measurement with the at least one second measurement to determine a change of a property of the mechanical system.

The present disclosure relates to a method and apparatus for monitoring a mechanical system.

Some types of machinery comprise components undergoing a periodic motion when in use. Example types of periodic motion include rotation, repeated translation, and reciprocating motion. A non-exhaustive list of examples of such moving components include, a piston ring on a reciprocating piston within an engine, a flight on a rotating feed screw in an extrusion machine/screw conveyor, and a vane of a rotating impellor within a pump etc. These types of machinery are utilised in a variety of different mechanical processes such as compressing a fluid mixture in an engine for combustion, transporting molten polymer using a feed screw, and pumping water or other fluids. It will be appreciated that it is important for these types of machinery to be reliable, since their failure may be difficult or expensive to rectify. Moving parts within such machinery can be subject to unpredictable wear/erosion due to varying qualities of adjacent fluid and/or internal conditions such as temperature or pressure. The moving parts are normally completely enclosed in a closed fluid-sealed environment and are difficult to access for inspection.

Non-invasive evaluation techniques such as ultrasound testing have been used to non-invasively monitor physically inaccessible components.

It is desirable to monitor the wear of moving parts within machinery in order that remedial action can be taken before any catastrophic failure occurs. Furthermore, it may be desirable to monitor a fluid or dry materials transported by such machinery for factors such as cavitation, aeration, and contamination, which can impact the rate of wear of the machinery.

### SUMMARY

According to a first aspect there is provided an apparatus for monitoring a mechanical system. The mechanical system comprises a moving surface arranged to undertake periodic motion, the periodic motion having a time period. The apparatus comprises a controller configured to control a first transducer to emit acoustic waves onto the moving surface during first and second time periods of the periodic motion. The controller is further configured to receive signals generated by the first transducer or a second transducer, wherein the received signals represent one or both of i) reflections of the acoustic waves from the moving surface and ii) acoustic waves having travelled through the mechanical system. The controller is further configured to process the received signals to obtain at least one first measurement indicative of a signal received during the first time period, and to obtain at least one second measurement indicative of a signal received during the second time period. The controller is further configured to compare the at least one first measurement with the at least one second measurement to determine a change of a property of the mechanical system.

The change of property may be a rate of change of a property.

The mechanical system as defined herein may refer to the moving surface and/or any fluid or material in contact with the moving surface.

Where the received signals represent reflections of acoustic waves from the moving waves, the received signals may be processed to obtain one first measurement indicative of a reflection occurring during the first time period and to obtain at least one second measurement indicative of a reflection occurring during the second time period.

Known ultrasound testing techniques aim to measure absolute distances between components, which can be inaccurate due to interactions between moving parts of the machinery and ultrasound waves. The monitoring system disclosed herein allows effects on an acoustic wave caused by moving parts of the mechanical system (e.g. “edge effects” caused by moving edges of one or more components of the mechanical system) to be taken into account by considering the change (or rate of change) of a measurement across multiple time periods, rather than by aiming to measure a distance precisely. The comparison may be performed over a significant number of periods, for example between a first time period and a 100,000^{th} time period. The comparison need not occur between directly adjacent time periods, for example, acoustic measurements may only be obtained every n^{th} (e.g. every 100^{th}) time period.

The mechanical system may comprise a machine including the moving surface, and a material (e.g., a fluid or dry particles) that is acted upon by the machine. The property of the mechanical system may be a property of a machine, a property of a material, or a combined property of both the machine and the material upon which the machine acts.

The periodic motion may be a rotational motion or a linear (e.g., reciprocating) motion.

An advantage of basing measurements on reflected waves is that reflected waves are particularly easy to decouple from the noise and the originally emitted waves, given that their energy has been reduced. However, principles of this disclosure also relate to processing of measurements indicative of waves that have travelled through any parts of the mechanical system.

Optionally, the acoustic waves are ultrasound waves.

The acoustic waves may be ultrasound waves having a frequency greater than 20 KHz, and/or up to several gigahertz. In this case, the transducer is an ultrasonic transducer. Where the mechanical system comprises a gas then the preferred frequency range is 40 kHz to 1 Mhz. Where the mechanical system comprises a liquid, the preferred frequency range is 250 KHz to 25 MHz.

Optionally, the at least one first measurement comprises a first plurality of measurements, and the at least one second measurement comprises a second plurality of measurements; and the controller is configured to compare the first plurality of measurements with the second plurality of measurements to determine the change of the property of the mechanical system.

Taking multiple measurements during each time period increases the spatial extent of the moving surface that can be monitored. For example, where a feature of interest of the moving surface is wider than a measurement area defined by a beam of the emitted acoustic waves, taking multiple measurements during each time period can allow the whole of the feature of interest to be captured as the moving surface moves through the beam. For example, for each time period, the multiple measurements can capture an entire cycle of the moving surface including all features that are observable by the transducer during movement of the moving surface during one time period.

Optionally, the first plurality of measurements comprises a first plurality of samples taken at predefined time intervals during the first time period; and the second plurality of measurements comprises a second plurality of samples taken at time intervals during the second time period that correspond to the predefined time intervals of the first time period.

Taking samples at corresponding predefined time intervals across each time period allows the mechanical system to be monitored at consistent points during the motion of the moving surface. In other words, measurements are synchronised with respect to (the period of) the motion of the moving surface. This provides an improved comparison of measurements between the different time periods, which in turn allows a change in the property of the mechanical system to be determined more accurately.

Optionally, the controller is further configured to: determine a reference model based on the first plurality of measurements; determine a test model based on the second plurality of measurements; and compare the test model with the reference model to determine the change of the property.

The reference model and/or the test model may be referred to herein as a comparison model. The controller may be configured to determine a plurality of test models corresponding to multiple additional measurements corresponding to multiple additional time periods. For example, the controller may generate several hundreds, thousands, or even millions of test models.

Optionally, each of the reference and test models comprises a curve fit to a plurality of data points corresponding to the first and second plurality of measurements, and the comparison comprises determining a similarity between the curves of the reference and test models.

Determining the reference and test models enables an improved comparison of the property between each time period. Plotting curves based on the measurements enables a visual comparison by a user. For example, where a curve has shifted position across multiple time periods, it can be determined that there is a change of property such as wear or pressure of a fluid. Furthermore, data relating to a property along the entire cycle of motion of the moving surface covered during each time period can be captured and visualised using plotted curves.

Optionally, the moving surface of the mechanical system comprises an element protruding from a base area, and the acoustic waves are emitted onto a measurement area of the moving surface, and the controller is further configured to obtain the at least one first measurement and/or the at least one second measurement when at least a portion of the element and the base area are within the measurement area.

Typically, the periodic motion comprises periodic movement of the moving surface comprising the element and the base area, said periodic movement being repeated each time period. The movement of the element and base area across the measurement area over each period may be referred to as one cycle of motion of the moving surface. The moving surface may comprise a base area being a screw shank of a non-advancing screw conveyor, and an element being a screw flight/thread. In this case, one cycle of motion of the moving surface comprises a passing of the screw flight and a portion of the screw shank across the measurement area. In other examples, the moving surface may comprise a hub of a rotary vane pump, and the element may be a vane of a pump. In examples, a fluid or dry material may be contained in a gap existing between the transducer and the base area, i.e. the fluid or dry material may be adjacent to the element.

Measurements where both of the base area and element are within the measurement area provide for an edge of the element to be analysed for a change in property. A comparison of multiple such measurements across different time periods provides an indication of a change in property such as wear, whilst “edge” effects on the measurements are accounted for. As an example, it can be determined whether sharp edges of an element are wearing and possibly becoming rounded due to wear. Advantageously, it is not necessary to calibrate the apparatus to ensure that the acoustic waves avoid the edge of the element, thereby leading to an easier and simpler setup of the monitoring apparatus.

The controller may be configured to control the first transducer to emit acoustic waves when at least a portion of the element and/or the base area are within the measurement area. In this manner, the controller can obtain the at least one first measurement and/or the at least one second measurement when the element and the base area are within the measurement area.

The controller may be configured to obtain multiple measurements during each time period as the element progresses through the measurement area. Each of such measurements may be made when the element is at a different position at least partially within the measurement area.

Obtaining multiple measurements as the element progresses through the measurement area allows a large portion of, or even the entirety of, the element to be monitored. It is possible that a property of the element changes unevenly along the element, e.g. uneven wear, and therefore it is desirable to obtain information relating to the entirety of the element, rather than being restricted to a measurement taken at a particular point on the element.

Optionally, the controller is further configured to obtain the at least one first and/or the at least one second measurement when an entire width of the element taken along an axis of the element corresponding to a direction of movement of the element is within the measurement area.

The monitoring system can analyse properties relating to elements that are small enough to completely fit within the measurement area. As discussed above, “edge” effects are accounted for and it is acceptable for there to be more than one edge of the element within the measurement area (e.g. both sides of the element). The system enables a “one size fits all” approach for size and configuration of transducers. It is advantageously not necessary to select specific types or sizes of transducer for use with the mechanical system being monitored.

Optionally, the received signals represent reflections of the acoustic waves from the moving surface, and the controller is configured to determine, for each measurement, a value of peak-to-peak amplitude of a reflected acoustic wave.

The peak-to-peak amplitude indicates the strength of the reflected acoustic wave and is therefore indicative of the closeness of phase-change boundaries to the transducer—e.g. the surface of the element and/or base area situated within a surrounding fluid. A small peak-to-peak amplitude is expected where there is a low amount of reflection, typically occurring if a top surface of the element is passing across the measurement area. Therefore, the shape and size of the element can be deduced from a plot of peak-to-peak amplitude. Changes in such a plot over a number of time periods may be indicative of a change in shape of the element, thereby indicating wear.

In one example, the mechanical system may comprise a piston cylinder in an engine, and the element protruding from the base area may be a piston ring. In this example, the monitoring apparatus may be configured to monitor wear of the piston ring. In another example, the mechanical system may comprise a screw conveyor, the element may be a thread of a screw, and the base area may be the surface of a shank. In this example, the monitoring system may be configured to monitor wear of the screw thread. In yet another example, the mechanical system may comprise a rotary vane pump, the element may be a vane, and the base area may be a rotational hub.

Optionally, the received signals represent reflections of the acoustic waves from the moving surface, and, wherein the controller is configured to determine, for each measurement, a time of flight measurement between the time of emission of the respective acoustic wave and the time of receiving the reflection of the emitted acoustic wave.

A time of flight measurement provides an indication of the closeness of a phase-change boundary to the transducer. A plot of time of flight measurements during a cycle of motion of the moving surface is typically indicative of the shape of the moving surface. For example, where the element is a thread/flight on a screw, then a curve plot of time of flight measurements covering the entire element and base area would be expected to be a rectangular plot. Variations to the curve could be indicative of wear. Additionally, the time of flight measurement enables an analysis of aeration or contamination in a fluid surrounding the elements, for example within a molten polymer being transported by a feed screw. Bubbles or contaminants may be visible via spikes or noise in the curve plot of time of flight measurements. By observing such a plot, a user can monitor aeration, cavitation and/or contamination in the fluid. Increased aeration or contamination can be indicative of a greater rate of wear of solid elements.

Optionally, the property comprises wear of the moving surface.

Optionally, the property comprises an amount of lubricant between the moving surface and the transducer.

Optionally, the property comprises aeration, cavitation and/or contamination of a fluid adjacent the moving surface and/or between the moving surface and the transducer.

Optionally, the fluid is a molten polymer or a molten metal.

Optionally, the apparatus further comprises the transducer, wherein the transducer is configured to be attached on an external side of an external casing of the mechanical system, the transducer further being configured to emit the acoustic waves through the external casing.

Placing the transducer on the external casing provides a high enough level of sensitivity to undertake the measurements discussed herein. The transducer may alternatively be placed within the external casing in order to have a direct acoustic line of sight to the measurement area, through any fluid that may exist within the mechanical system.

Optionally, the transducer and the controller are integrated within a single unit.

Optionally, the controller is located remotely to the transducer, and the controller is configured to communicate with the transducer via a communication network.

The transducer may be considered entirely passive, and comprise a piezoelectric element that is pulsed by the controller for emitting and receiving the wave. Processing of the signals may be undertaken on the controller. A waveform (or any sufficient metrics sufficient for describing the waveform) may be transmitted to a remote unit for further processing.

The controller, or any aspects of the controller discussed above, may be embodied in a server that is remote to the transducer. Signals may be transmitted between the transducer and the server via a communication network such as the Internet. Aspects of the controller may be embodied in a cloud computing environment. For example, analysis of any data obtained from the transducer may be undertaken utilising artificial intelligence or machine-learning techniques.

According to a second aspect there is provided a method for monitoring a mechanical system. The mechanical system comprises a moving surface arranged to undertake periodic motion, the periodic motion having a time period, the method comprising: controlling a first transducer to emit acoustic waves onto the moving surface during first and second time periods of the periodic motion; receiving signals generated by the first transducer or a second transducer, wherein the received signals represent one or both of i) reflections of the acoustic waves from the moving surface and ii) acoustic waves having travelled through the mechanical system; processing the received signals to obtain at least one first measurement indicative of a signal received during the first time period, and to obtain at least one second measurement indicative of a signal received during the second time period; and comparing the at least one first measurement with the at least one second measurement to determine a change of a property of the mechanical system.

Optionally, the acoustic waves are ultrasound waves.

Optionally, the at least one first measurement comprises a first plurality of measurements, and the at least one second measurement comprises a second plurality of measurements; and the controller is configured to compare the first plurality of measurements with the second plurality of measurements to determine the change of the property of the mechanical system.

Optionally, the first plurality of measurements comprises a first plurality of samples taken at predefined time intervals during the first time period; and the second plurality of measurements comprises a second plurality of samples taken at time intervals during the second time period that correspond to the predefined time intervals of the first time period.

Optionally, the controller determines a reference model based on the first plurality of measurements; determine a test model based on the second plurality of measurements; and compare the test model with the reference model to determine the change of the property.

Optionally, each of the reference and test models comprises a curve fit to a plurality of data points corresponding to the first and second plurality of measurements, and the comparison comprises determining a similarity between the curves of the reference and test models.

Optionally, the moving surface of the mechanical system comprises an element protruding from a base area, and the acoustic waves are emitted onto a measurement area of the moving surface, and the controller obtains the at least one first measurement and/or the at least one second measurement when at least a portion of the element and the base area are within the measurement area.

Optionally, the controller is further configured to obtain the at least one first and/or the at least one second measurement when an entire width of the element taken along an axis of the element corresponding to a direction of movement of the element is within the measurement area.

Optionally, the received signals represent reflections of the acoustic waves from the moving surface, and the controller is configured to determine, for each measurement, a value of peak-to-peak amplitude of a reflected acoustic wave.

Optionally, the received signals represent reflections of the acoustic waves from the moving surface, and, the controller determines, for each measurement, a time of flight measurement between the time of emission of the respective acoustic wave and the time of receiving the reflection of the emitted acoustic wave.

Optionally, the property comprises wear of the moving surface.

Optionally, the property comprises an amount of lubricant between the moving surface and the transducer.

Optionally, the property comprises aeration, cavitation and/or contamination of a fluid adjacent the moving surface and/or between the moving surface and the transducer.

Optionally, the fluid is a molten polymer or a molten metal.

According to a further aspect there is provided a computer program comprising instructions which, when the program is executed by a processor of a controller, cause the controller to carry out the method described herein.

According to a further aspect there is provided a computer-readable medium comprising instructions which, when executed by a processor of a controller, cause the controller to carry out the method described herein.

The skilled person will appreciate that except where mutually exclusive, a feature described in relation to any one of the aspects, examples or embodiments described herein may be applied to any other aspect, example, embodiment or feature. Further, the description of any aspect, example or feature may form part of or the entirety of an embodiment of the invention as defined by the claims. Any of the examples described herein may be an example which embodies the invention defined by the claims and thus an embodiment of the invention.

### BRIEF DESCRIPTION OF FIGURES

The invention will now be described, by way of example only, with reference to the accompanying drawings, in which:

FIG. 1 is a schematic diagram of a mechanical system and a monitoring system.

FIG. 2 is a diagram indicating an example direction of acoustic waves emitted by a transducer of the monitoring system shown in FIG. 1.

FIGS. 3a, 3b and 3c illustrate an example relationship between a measurement area of a transducer and a moving element of the mechanical system shown in FIG. 1.

FIGS. 4a and 4b are example plots of a comparison model utilising peak-to-peak values for analysing measurements.

FIG. 5 is a side-profile view showing example progressive wear degradation of an element of the mechanical system of FIG. 1.

FIG. 6 is a close-up diagrammatic representation of an interaction between acoustic waves and the mechanical system of FIG. 1.

FIG. 7 is an example acoustic waveform as received by the transducer of FIG. 1.

FIG. 8 is an example plot of an alternative comparison model utilising time-of-flight values for analysing measurements.

FIG. 9 is a diagram of a monitoring system arranged to monitor a screw feed device.

FIG. 10 is a diagram of a monitoring system arranged to monitor a rotary pump.

FIG. 11 is a diagram of a monitoring system arranged to monitor a reciprocating piston.

FIG. 12 is a diagram indicating the reciprocating piston of FIG. 11 at a different stage of reciprocation.

FIG. 13 is a flow diagram indicating an example process undertaken by a controller according to this disclosure.

### DETAILED DESCRIPTION

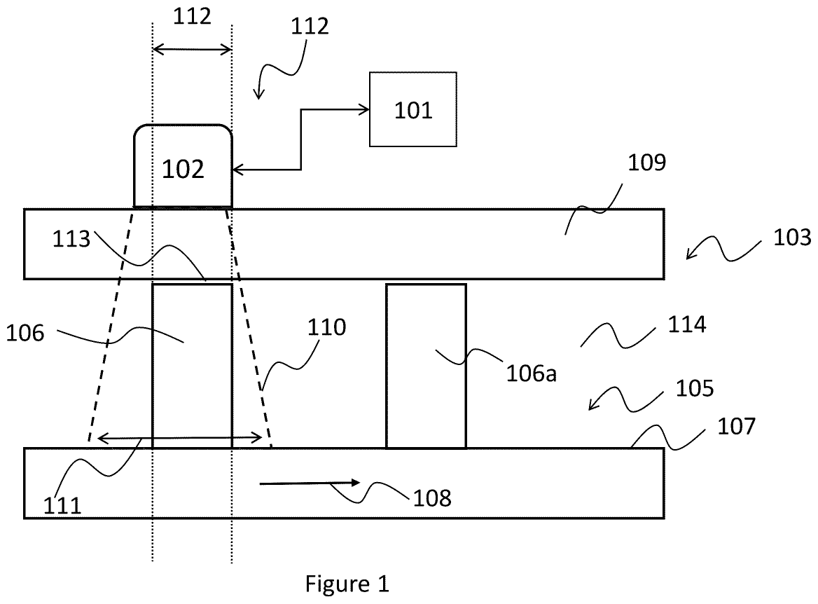

FIG. 1 shows a mechanical system 103, and an apparatus (112) (also referred to herein as a monitoring system) arranged to monitor the mechanical system 103. The monitoring system comprises a controller 101 and, in some embodiments, a transducer 102. The mechanical system 103 comprises a moving surface 105 undertaking a periodic motion during each of a plurality of time periods. The moving surface 105 comprises a three-dimensional geometry, which for ease of discussion, is exemplified as an element 106 protruding from a base area 107. The periodic motion may be motion in one direction according to arrow 108, wherein the element 106 and a portion of the adjacent base area 107 on one or both sides of the element passes the transducer 102 once during each time period. Motion of the moving surface 105 during one period of the periodic motion may be referred to as a cycle of motion. For example the base 107 may be equivalent to a conveyor belt in order that element 106 returns to the position shown in FIG. 1 after completing a circuit. Alternatively, the periodic motion may be side-to-side motion in relation to the direction of arrow 108, and the direction opposite to arrow 108. In the case of reciprocating motion, the element 106 and a portion of the adjacent base area 107 on one or both sides of the element passes the transducer twice during each cycle of motion, each pass being in an opposing direction. The transducer 102 may be separated from the moving parts of the mechanical system 103 by an external casing 109. The periodic motion may comprise another type of motion e.g. rotation.

The controller 101 is configured to control the transducer 102 to transmit acoustic waves onto the moving surface 105, and may be configured to process reflections of the acoustic waves received by the transducer 102 to obtain a measurement indicative of the reflection of the acoustic waves from the moving surface 105. As shown in FIG. 1, the monitoring system comprises a transducer 102 that is configured both to emit acoustic waves and to receive reflected acoustic waves. However, the monitoring system could comprise two transducers, where the transducer 102 is configured to emit acoustic waves and a second transducer (not shown in FIG. 1) is configured to receive reflected acoustic waves. Alternatively, the second transducer (not shown) may be configured to receive acoustic waves that have been emitted by the first transducer and have travelled through the mechanical system 103. The examples discussed herein relate to the measurement of reflected waves, however the principles discussed can be readily applied where the measurement is based on a through wave that has not been reflected. The acoustic waves may comprise ultrasonic pulses (also referred to as “signals”). The acoustic waves may comprise ultrasonic continuous waves. In a preferred example, the acoustic waves are ultrasound waves. As used herein, the terms “ultrasound” or “ultrasonic” refer to acoustic waves having a frequency higher than the typical upper audible limit of hearing, e.g. greater than 20 kilohertz. However, the controller may control emission of waves at other frequencies. The transducer 102 emits acoustic waves, which spread out as they leave the transducer to form a beam 110. The beam 110 may project onto a measurement area 111. Depending on the size of the beam 110, the measurement area 111 may be larger than a surface of the transducer 102 from which the acoustic waves are emitted.

When the mechanical system 103 is in use, and due to the periodic motion discussed above, the moving surface 105 will move so that the element 106 and base area 107 traverse across the measurement area 111 during a first time period. The motion is periodic, and therefore the moving surface 105 will repeatedly move so that element 106 and base 107 also traverse across the measurement area 111 during a second time period in the same manner as during the first time period. During each time period, the controller 101 may be configured to obtain one or more measurements. The system may comprise a plurality of elements that cross the measurement area 111 during each time period. For example, FIG. 1 shows an additional element 106a. Typically, the acoustic waves for obtaining the measurements are reflected off surfaces of the element 106 and/or the base area 107. A gap 114 exists between the moving surface 105 and the casing 109. The gap 114 is typically filled with a fluid such as air, lubricant, water, molten polymer, or molten aluminium. The gap 114 may be filled with a dry material such as grain, powder or any other solid comprising dry particles. Wherever the term “fluid” is used herein, it would be appreciated that this term may be substituted with a dry material that has fluid-mechanical properties. Therefore, the surfaces of the element 106 and base area 107 provide a phase change interface causing reflection of acoustic waves. The controller 101 is configured to process the received reflections. During the processing, the controller 101 is configured to compare a first measurement indicative of a reflection received during the first time period (i.e. a first measurement), with a second measurement indicative of a reflection received during the second time period (i.e. a second measurement). Based on this comparison, the controller determines a change of a property of the mechanical system 103.

The property of the mechanical system may be wear of the element 106 and/or base area 107. Alternatively, the property may relate to the fluid located in the gap 114 between the moving surface 105 and casing 109, e.g. a level of aeration, bubbles, or solid contaminants.

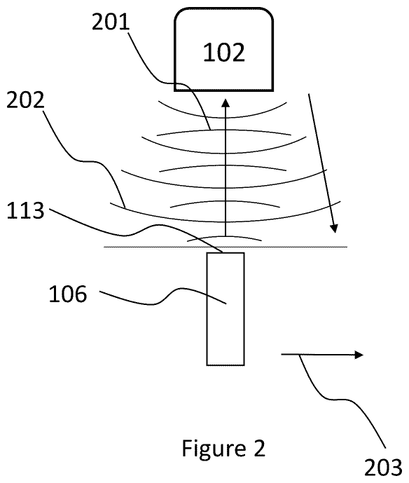

With continued reference to FIG. 1, it can be observed that the size of the measurement area 111 may be larger than the entire width of the element 106—the term “width” being used to describe the size of the element along the axis of movement in direction 108. As a result, some acoustic waves emitted by transducer 102 may cause reflections from both of the base area 107 surrounding the element 106, and a top surface 113 of the element 106. The reflections of such acoustic waves may cause errors in measurements of the distances of the top surface 113 of element 106 and the base area 107 from the transducer 102. This issue is further observable with reference to FIG. 2. It can be observed that not all emitted waves 202 are reflected from the top surface 113 of the element 106. Reflected waves 201 may or may not be reflected from the element 106 depending on the position of the element 106 in time, the element 106 moving along the direction of arrow 203.

Some known ultrasound testing techniques attempt to measure the absolute distance of the top surface 113 of the element 106 from the transducer 106. However, such distance measurements may be inaccurate for the reasons discussed above. In contrast, the techniques disclosed herein allow one or more properties of the mechanical system to be monitored without requiring an accurate distance measurement and whilst accounting for possible errors of the type discussed above.

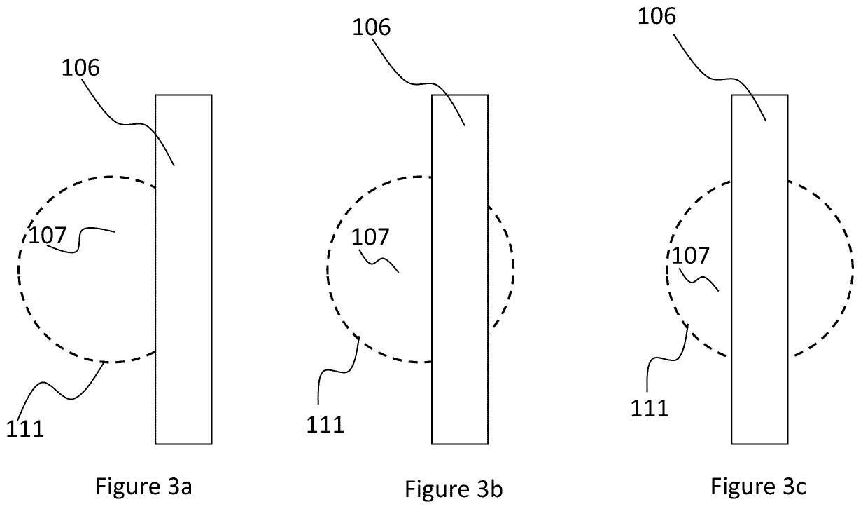

An example relationship between the measurement area 111 and element 106 is shown in FIGS. 3a-3c. FIG. 3a is a top-down view of the element at a first time instant where the element 106 is commencing a traversal across the measurement area 111 defined by the projection of the beam 110 (of FIG. 1) onto the moving surface 105. FIG. 3b shows the same features at a second time instant, after the first time instant, where the element 106 has moved towards the centre of the measurement area 111. FIG. 3c shows the same features at a third time instant, after the first and second time instants, where the element 106 has moved even further towards the centre of the measurement area 111. It can be observed from FIGS. 3a-3c that the measurement area 111 may overlap both of the element 106 and the base area 107. Furthermore, it can be observed that different sized portions of the element 106 and base area 107 are within the measurement area 111 at different time instants. FIGS. 3a-3c also indicate an example periodic movement of the element across the measurement area 111 during each of the plurality of periods (i.e. during a single cycle of motion). In examples, a measurement may be obtained at each time instant when the element 106 is in the position with respect to the measurement area 111 shown in each of FIGS. 3a, 3b, and 3c (or at other time instants within each of the plurality of periods).

It has been found that the change of a property of interest can be derived by comparing measurements taken during separate time periods. For example, three measurements can be taken during each time period, where each measurement corresponds to the position of the element 106 shown in each of FIGS. 3a, 3b, and 3c. Of course, more or fewer measurements can be taken during each time period. It is preferable, but not essential, for measurements to be taken at corresponding time instances during each time period in order to improve the quality of the comparison. Determining the change of a property such as wear or aeration is useful in order for users to predict when parts require maintenance or replacing, or to ascertain if the mechanical system is functioning correctly. The change of a property may be ascertained by determining differences or trends in measurements obtained over multiple time periods, perhaps thousands or even hundreds of thousand time periods. Each time period may correspond with a so-called cycle of the mechanical system—e.g., a cycle of a piston in an engine, or a single rotation of a screw in a screw feed machine. This approach is preferable to attempting to determine an accurate measurement of a property based on a single measurement, which can be subject to errors caused by impingement of acoustic waves on edge features of the element 106 and/or acoustic waves within the measurement area 111 being reflected off different types of surface.

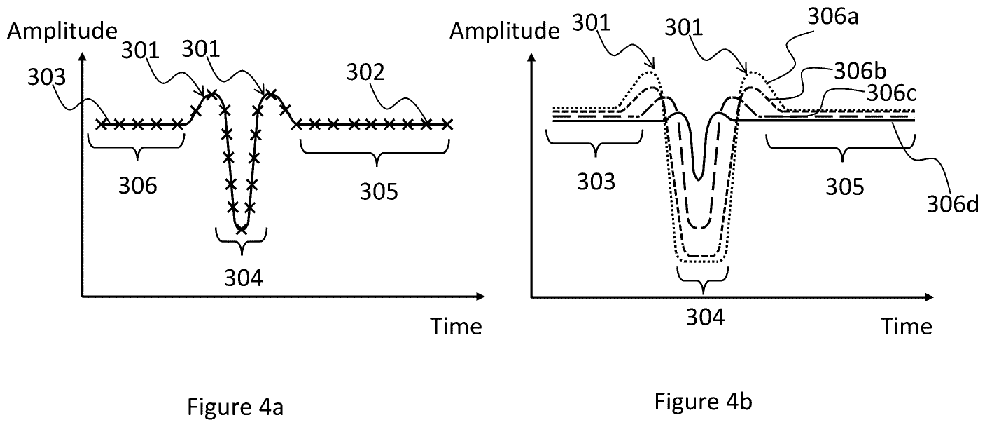

The controller 101 may be configured to process the measurements for undertaking different types of comparisons. A first example type of comparison is now discussed with reference to FIGS. 4a and 4b.

For each of the discussed example types of comparisons, the controller 101 is configured to obtain a plurality measurements during each time period. The mechanical system being analysed is exemplary and comprises an element 106 and surrounding base area 107 moving across a measurement area 111, where the element 106 is completely overlapped by the measurement area 111 at certain moments in time. This is similar to the type of relationship between the element and measurement area as discussed above with respect to FIGS. 3a-3c. It will be appreciated that the element is at a different location during each measurement. In this example, the element can be considered to “cross” the measurement area 111 undergoing a repetitive motion once per time period, whilst the controller obtains multiple measurements during each time period.

With reference to FIG. 4a, the controller 101 may be configured to process the measurements by creating a model such as a plot of peak-to-peak values 302 for each measurement. Each peak-to-peak value 302 is determined based on processing of a signal received by the transducer 102 and is plot at a time instant corresponding to the received signal. For example, each signal may comprise a pulse of acoustic waves and the peak-to-peak value is based on the difference between the maximum positive and maximum negative amplitudes of the waveform within each pulse. The peak-to-peak value may be a standard deviation of the amplitudes of waves within a pulse. The time instant may correspond to the time when the complete pulse has been received by the transducer 102. The pulse may be processed in alternative manners to extract different variables, for example only peaks above a certain amplitude threshold may be processed, a relationship between multiple peaks may be analysed, a Fast Fourier Transform (FFT) operation may be applied to the pulse waveform to determine variables such as energy, a phase of the pulse may be determined, the location of a zero crossing of the pulse waveform may be analysed. A curve 303 may be fitted to the plotted peak-to-peak values using a curve-fit algorithm, which may utilise a mathematical analysis such as polynomial regression. A higher peak-to-peak value may indicate less acoustic transmission through materials and is indicative of a surface existing further away from the transducer, beyond the casing 109. A lower peak-to-peak value indicates greater acoustic transmission through materials and is indicative of a surface existing closer to the transducer, e.g. the top surface 113 of the element 106 being separated by the casing 109 by a small amount and therefore the acoustic waves are dispersed to a greater degree through the element 106. Where the gap between the casing 109 and the top surface 113 of the element 106 is above a certain level, e.g. greater than a wavelength of the acoustic wave, then multiple reflections may be received—e.g. one from the top surface 113 and one from the interior side of the casing 109. The time between the reflections is a function of the distance between the top surface 113 and the interior side of the casing 109. A traversal of the element 106 across the measurement area 111 is observable in a plot of peak-to-peak amplitudes as measured at multiple time instances during the traversal, as can be seen in FIGS. 4a and 4b. A curve 301 fit to the peak-to-peak values illustrates different stages of the traversal of the element 106 during a time period. The stages 303 and 305 occur when a majority (or all) of the measurement area 111 comprises the base area 107, such as is shown in FIG. 4a. Stage 304 occurs as the element 106 crosses over a central portion of the measurement area 111, with the lower peak occurring when the element 106 is in the position shown in FIG. 3c. Each of a pair of upper peaks 301 occur as the element 106 commences crossing over the measurement area 111, and, as the element 106 departs the measurement area 111. The upper peak 301 arises due to so-called “edge effects”, caused by interaction of acoustic waves with an edge of the element 106. With reference to FIG. 4b, four curves 306a, 306b, and 306c, and 306d indicate measurements obtained during four corresponding time periods, over each of which, the element 106 has undertaken a repeated motion. The curves 306a, 306b, 306c, and 306d may relate to time periods that are spaced apart by thousands or hundreds of thousands of time periods. It can be observed that the shape of the curves varies for the different time periods. The change in shape is indicative of a change of a property of the mechanical system. For example, an amount of wear resulting in a change of shape of the element 106 (or even the base area 107) can be quantified with reference to the curves 306a, 306b, 306c, and 306d. Advantageously, the “edge effects” are compensated for and it is not necessary to accurately determine precise dimensions relating to the moving surface 105. Optionally, any of the plot curves discussed herein can be combined with a de-convolution of the reflected, received signal, or, fed into a machine learning/AI model, for determining a change of wear. For example, shape of the element 106 can be recovered from the curves 306a-d by de-convolving the measured signals with a known spatial impulse response of the transducer which is affected by the transducer (e.g. aperture size, frequency) as well as the medium the acoustic waves are travelling through (e.g. speed of sound). It is further not necessary for a user to utilise specific shaped transducers for different types of mechanical system, or be concerned about the effect of the size of the measurement area causing overlap with different moving parts of the mechanical system. The processing resulting in the plots of FIGS. 4a and 4b may be undertaken on the controller 101 and output to a personal computing device or server for further processing.

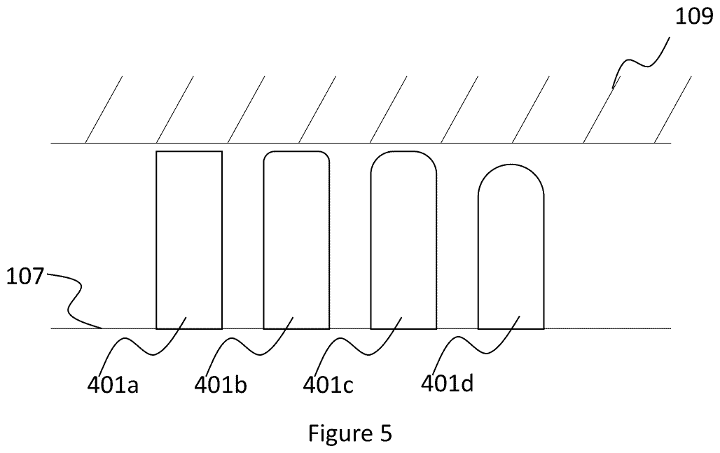

FIG. 5 illustrates an example property that is determined by aspects of the invention. In particular, FIG. 5 illustrates example side-profiles of elements 401a-d indicating progressive stages of wear across multiple time periods, with the element 401a indicating an example unused element 401a (i.e. during a first time period), and the element 401d indicating an example element having undergone a significant number of time periods. The elements 401a-d can be considered to indicate exemplary stages of wear as discernible via the corresponding curves 306a-d in FIG. 4b. It can be observed that, over the course of an increasing number of time periods, the top surfaces of the elements 401a-e progressively become rounded, and the elements 401a-e become shortened. A user can determine the rate of progression of the type of wear such as that represented in FIG. 5 with reference to a model such as that shown in FIG. 4b and need not be concerned with accurate measurements of any dimensions of the element 106.

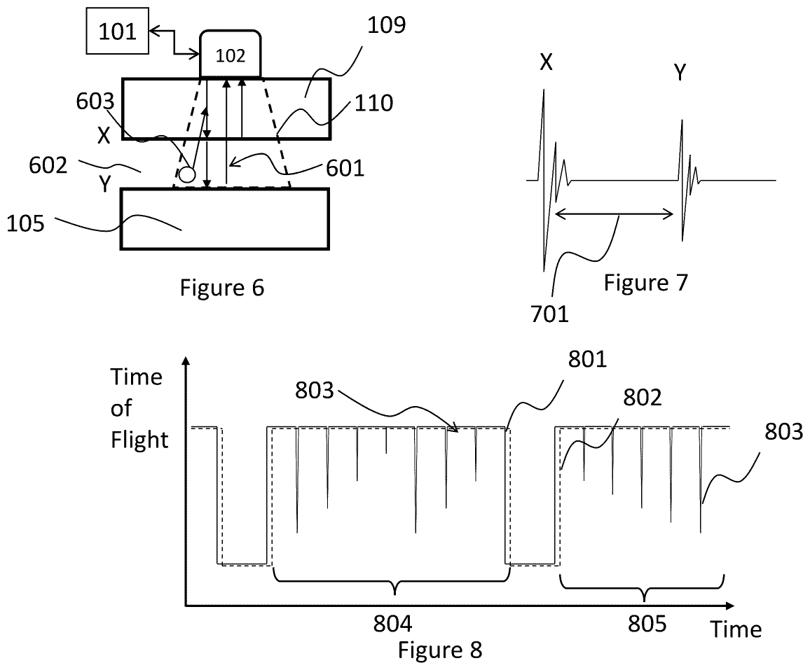

A second example type of comparison that may be undertaken by the controller 101 is discussed with reference to FIGS. 6 to 8.

FIG. 6 indicates a close-up view of the interface between the moving surface 105 (e.g. either the element 106 or the base area 107, or any combination thereof) and the external casing 109, of a system in accordance with FIG. 1. As discussed above, the transducer 102 is controlled by the controller 101 to emit acoustic waves and receive corresponding reflected acoustic waves. The direction of the emitted and reflected acoustic waves is indicated by arrows 601. A fluid gap 602 is between the moving surface 105 and the casing 109. The fluid gap 602 typically includes a fluid such as air, water, molten polymer, or lubricant. The fluid gap 602 may also include a dry material that has fluid-mechanical properties. FIG. 7 indicates an example reflected waveform received by the transducer 102 of FIG. 6. The pulse indicated by “X” relates to an initial reflection returned due to the boundary between the casing 109 and the fluid gap 602. The pulse indicated by “Y” relates to a subsequent reflection returned due to the boundary between the moving surface 105 and the fluid gap 602. A time-of-flight measurement is the time period 701 between the two pulses X and Y. With reference to FIG. 8, the controller can plot a series of time-of-flight measurements thereby providing a curve 801. The time-of-flight measurements are plotted at each time instance being when the entirety of the corresponding “Y” pulse has been received by the transducer 102. Each pulse X and Y may be split into a series of multiple pulses, and each corresponding time instant relates to the time when the last of the series of multiple pulses has been received by the transducer 102. The curve 801 is normally indicative of the shape of any elements crossing the measurement area provided by the beam 110 of the transducer. In the example of FIG. 8, there is an indication that two elements having similar shape have crossed the measurement area of the transducer (e.g. by reciprocating motion, or, the existence of two elements crossing in series).

Further information relating to properties of the mechanical system can be determined by the time-of-flight plot of FIG. 8. Regions 804 and 805 comprise “spikes” or interference 803. These are caused by regions between elements (i.e. in the fluid gap 602) that comprise small phase-change areas such as air bubbles (where the fluid is a liquid). For example, returning to FIG. 6, a bubble 603 within the fluid gap causes an additional reflection of the emitted acoustic waves, thereby generating an additional pulse which creates a time-of-flight measurement different to that measured for the surrounding moving surface 105. The spikes 803 could also be caused by particulate matter, indicating solid contamination of a liquid. The number of spikes can be monitored over multiple time periods in order to track levels or aeration/contamination. Increasing numbers of spikes could be indicative of increased wear, due to impurities in the fluid gap 602. In addition, dotted curve 802 indicates an example time-of-flight plot obtained at a different time period, and appears to be a time “shift” of the plot for the solid curve 801. Such a shift could be indicative of a change of pressure in the fluid gap 601, since the time-of-flight values also depends on the pressure within the fluid gap 601.

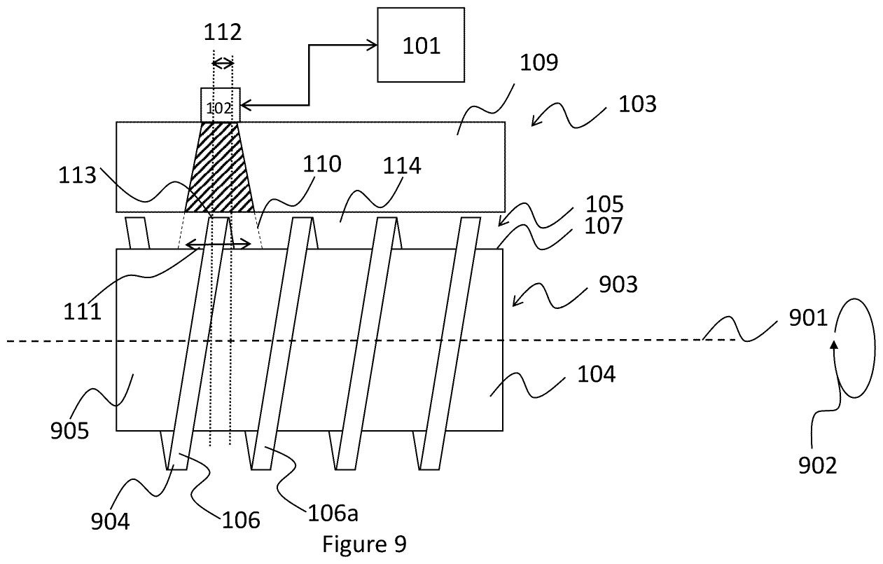

With reference to FIG. 9, there is an example implementation of the monitoring system discussed above. The reference numerals of FIG. 9 correspond to the features discussed above. The example of FIG. 9 is a screw feed device which may transport molten polymer within the fluid gap 114 and between elements 106 and 106a, which form a thread (or flight) of a screw 903. The thread 904 is about a shank 905 (or root) of the screw 903. The shank 905 corresponds to the base area 107 discussed above. In use, the screw 903 rotates about axis 901 in the direction that is indicated by arrow 902 but does not move along the axis 901. Utilising the principles discussed above, the controller obtains measurements for monitoring properties such as a rate of wear of the flight 904 and/or shank 905 . . . . Furthermore, the controller may obtain measurements for monitoring levels of aeration or solid contamination in a fluid located within the fluid gap 114. In this example, a time period as discussed above is the time taken for the completion of a cycle of motion being a complete 360 degree rotation of the screw 903. The periodic motion is rotation of the screw thereby causing the screw thread 904 to translate across the measurement area 111 in one direction as observed by the transducer 102. Over each period, the same portion of screw thread 904 and adjacent shank 905 is passes across the measurement area 111. The rate of wear of aspects of the screw 903 may be monitored by the analysis discussed with respect to FIGS. 4a, 4b, and 5. The rate of wear can be considered to be a relatively slow and permanent change over multiple time periods. Other, more rapid or temporal changes relate to changes caused by process changes e.g. contaminants within the molten polymer, and can be monitored by the analysis discussed with respect to FIGS. 6 to 8.

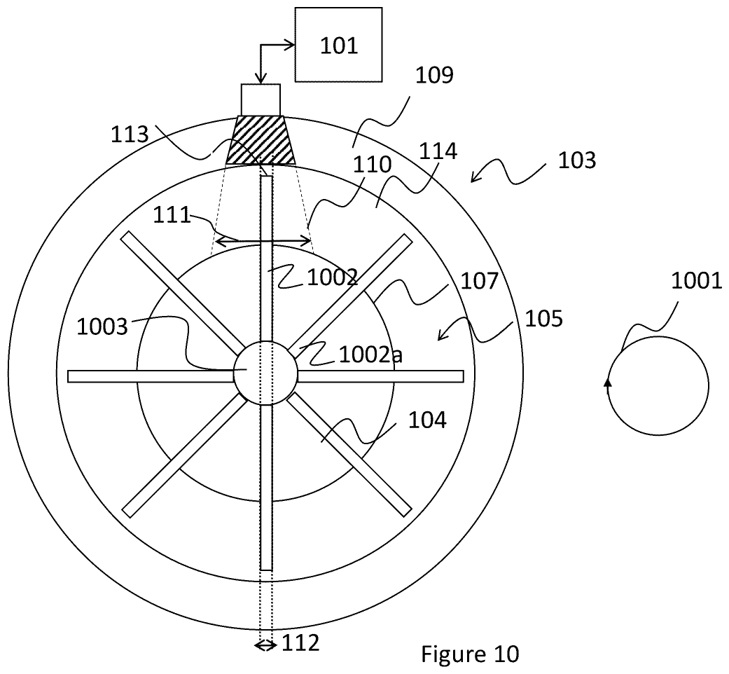

With reference to FIG. 10, there is a further example implementation of the monitoring system discussed above. The reference numerals of FIG. 10 correspond to the features discussed above. The example of FIG. 10 is a rotating vane pump, where a fluid within the fluid gap 114, such as water, is pumped due to interaction with rotating vanes 1002, 1002a. The vanes 1002, 1002a rotate about a hub 1003 in the direction indicated by arrow 1001. The vanes 1002, 1002a may be considered equivalent to the elements 106 discussed above. The hub 1003 may be considered equivalent to the base area 107 discussed above. Utilising the principles discussed above, the controller obtains measurements for monitoring properties such as a rate of wear of the vanes 1002, 1002a and/or the hub 1003. Furthermore, it is possible to monitor levels of aeration or solid contamination in a fluid located within the fluid gap 114. In this example, a time period as discussed above is the time taken for completion of a cycle of motion being a complete 360 degree rotation of the vanes 1002, 1002a about the hub 1003. Multiple vanes 1002 and 1002a may pass across the measurement area 111 during each time period. The controller may be configured to account for multiple elements 106, and 106a based on patterns in any model, such as that discussed with respect to FIG. 4b and FIG. 8. For example, if only a particular element 106 in the system is undergoing wear, e.g. one particular vane 1002, then this is detected based on a change of one particular peak observed in the plots of FIGS. 4b and 8.

The principles discussed above may be applied to multiple types of mechanical pump, e.g. centrifugal pumps, peristaltic pumps, impellor pumps, and reciprocating pumps.

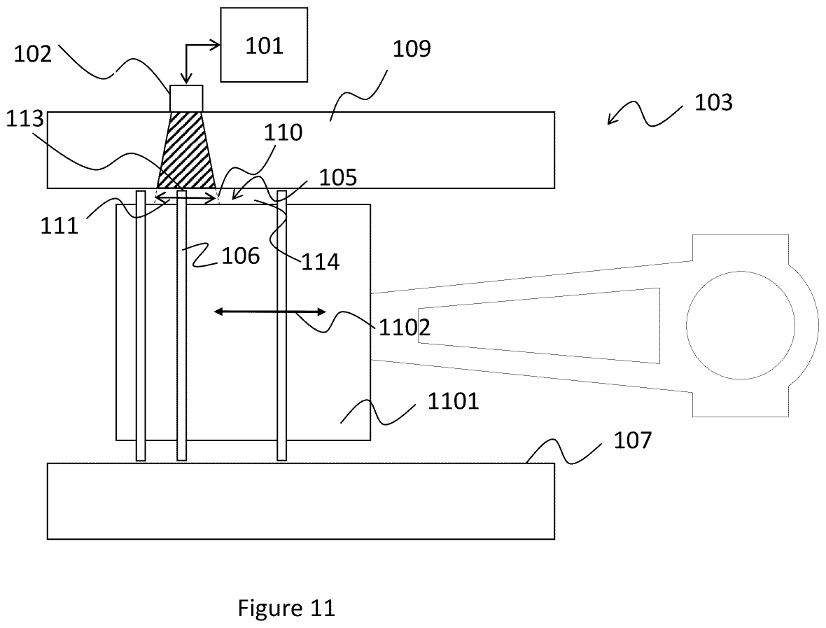

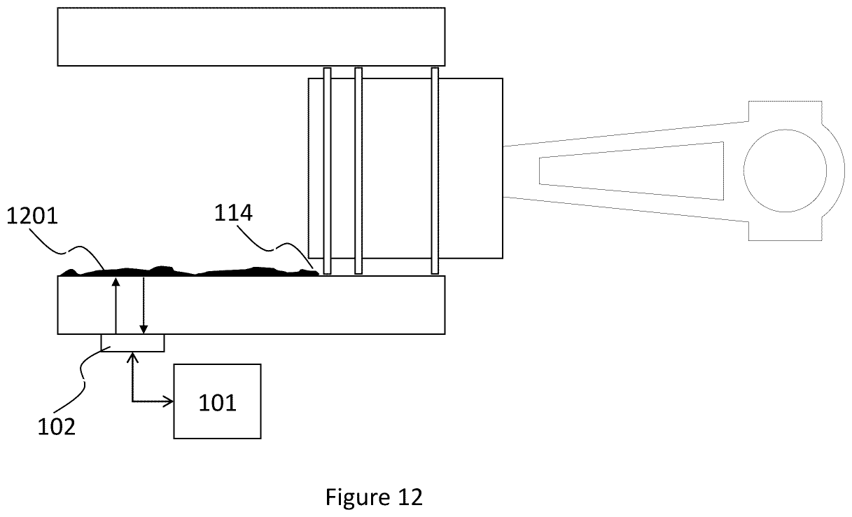

With reference to FIG. 11, there is a further example implementation of the monitoring system discussed above. The reference numerals of FIG. 11 correspond to the features discussed above. The example of FIG. 11 is a reciprocating piston such as the type found in an internal combustion engine. In this example, the fluid within fluid gap 114 may be a lubricant. When the system is in use, a head of the piston 1101 translates in alternating directions as indicated by arrow 1102. In this case, the relevant cycle of motion of is a translation of the element 106 (which is a piston ring in this example) backwards and forwards across the measurement area 111 during one cycle of the piston (i.e. an upward and a downward stroke of the piston) . . . . Multiple elements (e.g. multiple piston rings) may pass the measurement area during each cycle. Utilising the principles discussed above, the controller obtains measurements for monitoring properties such as a rate of wear of the element 106 (piston ring), and levels of aeration or solid contamination in the fluid (e.g. lubricant) located within the fluid gap 114. For further helping to explain the example of FIG. 11, FIG. 12 indicates the system of FIG. 11 with the piston in a different position. A lubricant 1201 is within the fluid gap 114. The lubricant 1201 can be monitored for levels, aeration, or solid contamination.

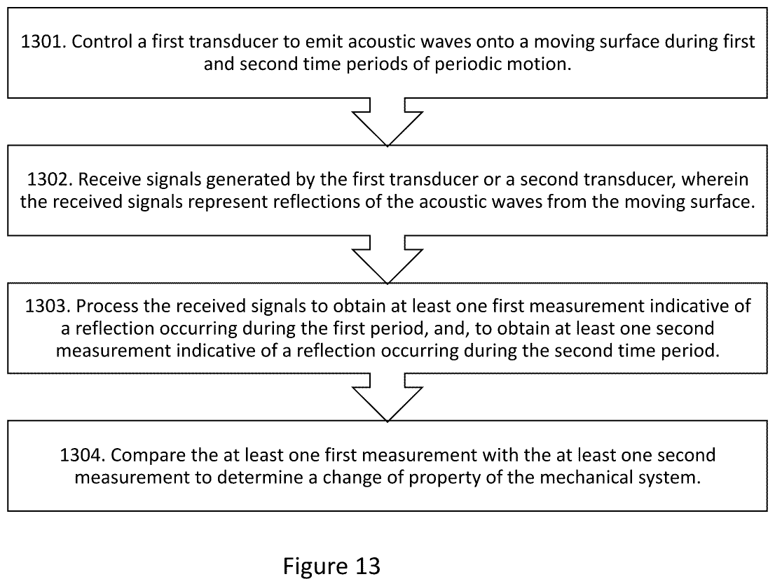

With reference to FIG. 13, there is a process flow diagram indicating an example process undertaken by the controller 101 for monitoring a mechanical system, wherein the mechanical system comprises a moving surface arranged to undertake periodic motion, the periodic motion having a time period. During step 1301, a first transducer is controlled to emit acoustic waves onto a moving surface during first and second time periods of periodic motion. During step 1302, the first transducer or a second transducer receives signals generated by the first transducer, wherein the received signals represent reflections of the acoustic waves from the moving surface. During step 1303, the received signals are processed to obtain at least one first measurement indicative of a reflection occurring during the first period, and, to obtain at least one second measurement indicative of a reflection occurring during the second time period. During step 1304, the at least one first measurement is compared with the at least one second measurement to determine a change of property of the mechanical system. The change of property may be a change of property.

The term “comparison model” as used herein relates to a model of measurements such as a plot of one or more curves of the peak-to-peak analysis discussed with respect to FIG. 4b, or, the time-of-flight analysis discussed with respect to FIG. 8.

The controller may be embodied within any of a personal computer (PC), a field programmable gate array (FPGA), or any other type of computational device capable of being programmed. The controller may comprise a processor that is instructed by instructions provided by a computer program which is embodied on a computer-readable medium. The controller may comprise a network connection for connection to a remote server, and any aspect of the controller e.g. processing of measurements and generation of any models discussed herein may take place on the remote server or within a cloud computing environment. The controller may comprise local memory for storing data relating to measurements, and/or means for transmitting said data to a remote server or another computing device located remotely, before further processing. The controller may include the discussed transducer as an integral component, or, the controller may be a standalone device that is configured to be electronically connectable to a transducer.

It will be understood that the invention is not limited to the examples and embodiments above-described and various modifications and improvements can be made without departing from the concepts described herein. Except where mutually exclusive, any of the features may be employed separately or in combination with any other features and the disclosure extends to and includes all combinations and sub-combinations of one or more features described herein.

1. An apparatus for monitoring a mechanical system, wherein the mechanical system comprises a moving surface arranged to undertake periodic motion, the periodic motion having a time period, the apparatus comprising a controller configured to:
control a first transducer to emit acoustic waves onto the moving surface during first and second time periods of the periodic motion;
receive signals generated by the first transducer or a second transducer, wherein the received signals represent one or both of i) reflections of the acoustic waves from the moving surface and ii) acoustic waves having travelled through the mechanical system;
process the received signals to obtain at least one first measurement indicative of a signal received during the first time period, and to obtain at least one second measurement indicative of a signal received during the second time period; and
compare the at least one first measurement with the at least one second measurement to determine a change of a property of the mechanical system.

2. The apparatus of claim 1, wherein the acoustic waves are ultrasound waves.

3. The apparatus of claim 1, wherein:
the at least one first measurement comprises a first plurality of measurements, and the at least one second measurement comprises a second plurality of measurements; and
the controller is configured to compare the first plurality of measurements with the second plurality of measurements to determine the change of the property of the mechanical system.

4. The apparatus of claim 3, wherein:
the first plurality of measurements comprises a first plurality of samples taken at predefined time intervals during the first time period; and
the second plurality of measurements comprises a second plurality of samples taken at time intervals during the second time period that correspond to the predefined time intervals of the first time period.

5. The apparatus of claim 3, wherein the controller is further configured to:
determine a reference model based on the first plurality of measurements;
determine a test model based on the second plurality of measurements; and
compare the test model with the reference model to determine the change of the property.

6. The apparatus of claim 5, wherein each of the reference and test models comprises a curve fit to a plurality of data points corresponding to the first and second plurality of measurements, and wherein the comparison comprises determining a similarity between the curves of the reference and test models.

7. The apparatus of claim 1,
wherein the moving surface of the mechanical system comprises an element protruding from a base area, the acoustic waves are emitted onto a measurement area of the moving surface, and the controller is further configured to obtain the at least one first measurement and/or the at least one second measurement when at least a portion of the element and the base area are within the measurement area.

8. The apparatus of claim 7, wherein the controller is further configured to:
obtain the at least one first and/or the at least one second measurement when an entire width of the element taken along an axis of the element corresponding to a direction of movement of the element is within the measurement area.

9. The apparatus of claim 1, wherein the received signals represent reflections of the acoustic waves from the moving surface, and, wherein the controller is configured to determine, for each measurement, a value of peak-to-peak amplitude of a reflected acoustic wave.

10. The apparatus of claim 1, wherein the received signals represent reflections of the acoustic waves from the moving surface, and, wherein the controller is configured to determine, for each measurement, a time of flight measurement between the time of emission of the respective acoustic wave and the time of receiving the reflection of the emitted acoustic wave.

11. The apparatus of claim 1, wherein the property comprises wear of the moving surface.

12. The apparatus of claim 1, wherein the property comprises an amount of lubricant between the moving surface and the transducer.

13. The apparatus of claim 1, wherein the property comprises aeration, cavitation and/or contamination of a fluid adjacent the moving surface and/or between the moving surface and the transducer.

14. The apparatus of claim 13, wherein the fluid is a molten polymer or a molten metal.

15. The apparatus of claim 1, the apparatus further comprising the transducer, wherein the transducer is configured to be attached on an external side of an external casing of the mechanical system, the transducer further being configured to emit the acoustic waves through the external casing.

16. The apparatus of claim 15, wherein the transducer and the controller are integrated within a single unit.

17. The apparatus of claim 1, wherein the controller is located remotely to the transducer, and wherein the controller is configured to communicate with the transducer via a communication network.

18. A method for monitoring a mechanical system, wherein the mechanical system comprises a moving surface arranged to undertake periodic motion, the periodic motion having a time period, the method comprising:
controlling a first transducer to emit acoustic waves onto the moving surface during first and second time periods of the periodic motion;
receiving signals generated by the first transducer or a second transducer, wherein the received signals represent one or both of i) reflections of the acoustic waves from the moving surface and ii) acoustic waves having travelled through the mechanical system;
processing the received signals to obtain at least one first measurement indicative of a signal received during the first time period, and to obtain at least one second measurement indicative of a signal received during the second time period; and
comparing the at least one first measurement with the at least one second measurement to determine a change of a property of the mechanical system.

19. (canceled)

20. A non-transitory computer-readable medium comprising instructions which, when executed by a processor of a controller, cause the controller to carry out the method of claim 18.
